(19) United States
(12) Patent Application Publication
(10) Pub. No.: US 2022/0110363 A1
(43) Pub. Date: Apr. 14, 2022

(54) AUTOMATIC VAPOR DISPENSING DEVICES AND METHODS

(71) Applicant: Bello Vaporizer, Sudbury, MA (US)

(72) Inventor: Ian Carlson, Sudbury, MA (US)

(21) Appl. No.: 17/413,919

(22) PCT Filed: Dec. 14, 2019
(86) PCT No.: PCT/US19/66417

§ 371 Date: Jun. 14, 2021

Related U.S. Application Data
(60) Provisional application No. 62/780,078, filed on Dec. 14, 2018.

(51) Int. Cl. A24F 40/42; A24F 40/48; A24F 40/51; A24F 40/53; A24F 40/46; A24F 40/60

(52) U.S. Cl. CPC A24F 40/42; A24F 40/48; A24F 40/60; A24F 40/53; A24F 40/46; A24F 40/51

(57) ABSTRACT

Devices configured to vaporize solid and liquid materials, including but not limited to cannabinoid solutions, nicotine solutions, herbs, tobacco, cannabis, essential oils, and concentrates thereof, are disclosed. The vaporized materials are dispensed from the devices whenever a receptacle having the proper opening in a bottom thereof is detected over an outlet of the device, thereby triggering the heating device and/or opening of a seal between the heating chamber of the device and the receptacle. This automatic dispensing reduces hassle and human error.

### CROSS-REFERENCE TO RELATED APPLICATIONS

This application claims the benefit of and priority to U.S. Provisional Patent Appl. No. 62/780,078, filed Dec. 14, 2018, which is hereby incorporated by reference in its entirety.

### BACKGROUND

Various receptacles, such as bags, balloons and whips, exist for collecting vapor from tabletop vaporizers. However, users of these devices are required to manually start the flow of vapor into the receptacle every time filling is desired and to stop the flow of vapor into the receptacle every time the user wishes to inhale the vapor. Thus, it is not uncommon for the flow of vapor to be accidentally left open causing waste of consumable material to the surrounding environment or rupture of the receptacle due to excessive pressure. Contrarily, the flow of vapor may be accidentally stopped when the user intends to fill the receptacle, thereby delaying enjoyment and/or causing the vapor to be held in the heating chamber, which can lead to overheating and chemical degradation of the material.

### SUMMARY

The present invention relates to devices configured to vaporize solid and liquid materials, including but not limited to cannabinoid solutions, nicotine solutions, herbs, tobacco, cannabis, essential oils, and concentrates thereof. The vaporized materials are dispensed from a device whenever a receptacle having the proper opening in a bottom thereof is detected over an outlet of the device, thereby triggering the heating device and/or opening of a seal between the heating chamber of the device and the receptacle. This automatic dispensing reduces hassle and human error.

In an aspect, a vapor dispensing device comprises a chamber in thermal communication with a heating device such that a solid or a liquid within the chamber is heated and converted into a vapor; a receptacle, in fluid communication with an outlet of the chamber, for receiving the vapor through an opening in a bottom of the receptacle; and a sensor for detecting the presence or absence of the receptacle over the outlet of the chamber and providing detection data to a processor, the processor instructing the heating device to activate when the receptacle is present and to deactivate when the receptacle is absent.

In an aspect, a vapor dispensing device comprises a chamber in thermal communication with a heating device such that a solid or a liquid within the chamber is heated and converted into a vapor; a receptacle, in fluid communication with an outlet of the chamber, for receiving the vapor through an opening in a bottom of the receptacle; a seal between the receptacle and the chamber, wherein the seal is operated by a switch; and a sensor for detecting the presence or absence of the receptacle over the outlet of the chamber and providing detection data to a processor, the processor instructing the switch to open the seal when the receptacle is present and to close the seal when the receptacle is absent.

In an embodiment, the chamber is in fluid communication with a fan or a blower that facilitates movement of the vapor from the chamber to the receptacle. For example, in an embodiment, the fan or the blower is selected from the group consisting of an electric fan, an electric pump, a piezoelectric fan, a piezoelectric pump, a manual fan, a manual pump, a pneumatic fan and a pneumatic pump. In an embodiment, the fan or blower provides sufficient pressure to force the vapor through a liquid. For example, the fan or blower pressure may be manually adjusted or selected by a processor monitoring conditions of the device.

In an embodiment, the chamber is configured to receive a cartridge comprising the solid or the liquid. A cartridge may, for example, be an industry standard cartridge known in the tobacco, nicotine, vitamin, essential oil or cannabis fields.

In an embodiment, the processor further instructs the heating device to turn on when the receptacle is present and to turn off when the receptacle is absent. In an embodiment, a sensor for detecting the presence or absence of a receptacle is a light sensor, a magnetic sensor, a mass sensor, a pressure sensor, an infrared sensor, a wireless electronic receiver (e.g., a near-field device, a radio frequency receiver) or a combination thereof. In an embodiment, a sensor communicates with a processor that accesses memory comprising non-transient machine-readable instructions, which may be executed by the processor to control one or more of a seal, a switch, a heating device, a fan, a blower, a filling device and a power source.

In an embodiment, the heating device is a convective heating device, a conductive heating device, or a combination thereof. For example, the heating device may be selected from the group consisting of a resistive element, a heating bath, a flame and combinations thereof. In an embodiment, a heating device provides energy to the chamber until the user removes the receptacle from the outlet of the chamber, until a manufacturer or user specified period of time has passed, until a set temperature is reached, or until a malfunction is detected. In an embodiment, a heating device may be controlled by a thermostat with or without temperature sensor feedback.

In an embodiment, the receptacle further comprises one or more outlets, such as mouthpieces and/or air vents.

In an embodiment, the seal is located within the receptacle, a device housing the chamber, or partially within the receptacle and partially within the device housing the chamber. For example, the seal may be magnetic, electromagnetic, mechanical or electromechanical.

In an embodiment, the switch is magnetic, electromagnetic, mechanical or electromechanical and/or electric (digital). For example, the switch may be a solenoid, a mechanical switch, an electronic switch or a transistor.

In an embodiment, the vapor dispensing device further comprises a filling device comprising a rigid or flexible member with a perimeter smaller than a perimeter of the opening, the rigid or flexible member including a passage along a longitudinal axis and one or more apertures through a sidewall of the rigid or flexible member, the apertures in fluid communication with the passage and with an interior of the receptacle.

In an embodiment, in the open position, the one or more apertures of the rigid or flexible member are located within the interior of the receptacle.

In an embodiment, the filling device further comprises a vapor flow controller. In an embodiment, the vapor flow controller controls the direction of vapor/air flow, the rate of vapor/air flow or both. The ability to control vapor flow direction and/or rate may be beneficial for diverting vapor from immediately exiting a receptacle, instead facilitating pooling of the vapor at a particular location within a receptacle, e.g., a bottom of a receptacle, a top of a substantially enclosed receptacle, a side(s) of a receptacle or a middle of receptacle. In an embodiment, a vapor flow controller comprises an object, such as a plate, disposed a set distance or adjustable distance from the opening in the receptacle and positioned to deflect or reflect a flow of vapor from its natural, dominant path. In an embodiment, a vapor flow controller is positioned substantially perpendicular to a vapor flow trajectory, which may, for example, be substantially vertical with respect to the Earth.

In an aspect, a vapor dispensing device comprises a chamber in thermal communication with a heating device such that a solid or a liquid within the chamber is heated and converted into a vapor; a receptacle, in fluid communication with an outlet of the chamber, for receiving the vapor at an opening in a bottom of the receptacle; a seal attached to the receptacle at the opening, the seal comprising a valve biasing the seal in a closed fluid-tight position via magnetic attraction of opposing first and second components, each of the opposing first and second components including a magnetic material; and a filling device configured to fill the receptacle with a vapor, the filling device comprising a rigid member with a perimeter smaller than a perimeter of the opening, the rigid member including a passage along a longitudinal axis and one or more apertures through a sidewall of the rigid member, the apertures in fluid communication with the passage, wherein the seal is transitioned from the closed fluid-tight position to an open position by pressing the rigid member against one of the opposing first and second components to place the one or more apertures in fluid communication with an interior of the receptacle.

In an embodiment, the filling device comprises a platform surrounding the rigid or flexible member, the platform configured to translate along a length of the rigid or flexible member.

In an aspect, a method of dispensing a vapor comprises providing a chamber in thermal communication with a heating device such that a solid or a liquid within the chamber is heated and converted into a vapor; detecting with a sensor the presence or absence of a receptacle over an outlet of the chamber, wherein the receptacle comprises an opening in a bottom thereof; and instructing the heating device to turn on or off based on whether the sensor detects the presence or absence of the receptacle, respectively.

In an aspect, a method of dispensing a vapor comprises providing a chamber in thermal communication with a heating device such that a solid or a liquid within the chamber is heated and converted into a vapor, detecting with a sensor the presence or absence of a receptacle over an outlet of the chamber, wherein the receptacle comprises an opening in a bottom thereof, and instructing a switch to open or close a seal at the outlet of the chamber based on whether the sensor detects the presence or absence of the receptacle, respectively.

In an aspect, a vapor dispensing device comprises a chamber in thermal communication with a heating device such that a solid or a liquid within the chamber is heated and converted into a vapor; a seal at an outlet of the chamber, the seal comprising a valve biasing the seal in a closed fluid-tight position; a switch for transitioning the seal from the closed fluid-tight position to an open position when a receptacle is detected in fluid communication with the outlet of the chamber and to close the seal when the receptacle is not in fluid communication with the outlet of the chamber, the receptacle receiving the vapor from the chamber at an opening in a bottom of the receptacle when the seal is in the open position; and a fan that facilitates movement of the vapor from the chamber to the receptacle.

In an embodiment, the receptacle comprises a diffuser disposed within the opening in the bottom of the receptacle. Generally, the diffuser comprises a gasket and a fluid conduit. In an embodiment, the diffuser may be made of a rigid or flexible food-grade material such as, but not limited to, rubber or silicone. In an embodiment, the fluid conduit comprises one or more outlets for directing vapor in a substantially lateral direction relative to a main axis of the fluid conduit. In an embodiment, the main axis of the fluid conduit may be sealed distal to the bottom of the receptacle.

In an embodiment, the receptacle further comprises one or more outlets. For example, in some embodiments, the receptacle is shaped substantially like a cup having an opening in a bottom and a mouth/outlet at a top of the receptacle. In other embodiments, the receptacle may include a plurality of outlets for multiple users.

In an embodiment, the switch that transitions the seal from the closed position to the open position is operated manually, for example, by applying pressure to the switch.

In an embodiment, the presence or absence of the receptacle is detected by a sensor that provides detection data to a processor that instructs the heating device to turn on or ramp up when the receptacle is present and to turn off or ramp down when the receptacle is absent. In an embodiment, the heating device operates in low mode or off mode in the absence of the receptacle, thereby preserving battery life. For example a quiescent current may be less than 600 mA.

In an embodiment, the presence or absence of the receptacle is detected by a sensor that provides detection data to a processor that instructs the fan to turn on or speed up when the receptacle is present and to turn off or slow down when the receptacle is absent.

A cleaning cycle may be useful, for example, to remove build up of concentrate within the device. For example, a cleaning cycle may involve use of increased heat and/or pressure to “burn off” residue. In an embodiment, the vapor dispensing device further comprises a non-transitory computer-readable medium having a plurality of non-transitory instructions executable by a processor for cleaning the device, the plurality of non-transitory instructions being executable for activating the heating device to raise a temperature of the chamber to at least 200 degrees Fahrenheit; and/or activating the fan to provide a pressure of at least 10 psi. In an embodiment, the temperature of the chamber is raised to at least 300 degrees Fahrenheit, or at least 350 degrees Fahrenheit, or at least 400 degrees Fahrenheit, or at least 450 degrees Fahrenheit, at least 500 degrees Fahrenheit, or at least 550 degrees Fahrenheit. In an embodiment, the pressure of the chamber is at least 40 psi, or at least 50 psi, or at least 80 psi, or at least 100 psi, or at least 120 psi.

In an aspect, a method of dispensing a vapor from a device comprises providing the vapor dispensing device disclosed herein; detecting with a sensor the presence or absence of a receptacle over an outlet of the chamber; and causing: (i) the heating device to increase or decrease a temperature of the chamber based on whether the sensor detects the presence or absence of the receptacle, respectively; (ii) the switch to open or close the seal at the outlet of the chamber based on whether the sensor detects the presence or absence of the receptacle, respectively; and/or (iii) the fan to increase or decrease its speed based on whether the sensor detects the presence or absence of the receptacle, respectively.

In an aspect, a method of dispensing vapor comprises providing a vapor dispensing device disclosed herein; placing a solid or liquid within the chamber of the vapor dispensing device; delivering power to the device to heat the chamber and convert the solid or liquid into vapor; and placing the receptacle comprising the opening in the bottom of the receptacle over the outlet of the chamber, thereby causing the switch to transition the seal at the outlet of the chamber to the open position and the vapor to be dispensed into the receptacle.

In an aspect, a method of dispensing vapor further comprises inserting a diffuser in the opening in the bottom of the receptacle before placing the receptacle over the outlet of the chamber.

### BRIEF DESCRIPTION OF THE DRAWINGS

Illustrative embodiments of the present invention are described in detail below with reference to the attached drawings, wherein:

FIG. 1 shows a block diagram of an exemplary vapor dispensing device, according to an embodiment;

FIG. 2 is a cross sectional illustration of an exemplary diffuser for use in a receptacle, according to an embodiment;

FIG. 3 is a perspective view of the diffuser of FIG. 2; and

FIG. 4 is a cross sectional illustration of the diffuser of FIG. 2 within a receptacle, according to an embodiment.

### DETAILED DESCRIPTION

In general, the terms and phrases used herein have their art-recognized meaning, which can be found by reference to standard texts, journal references and contexts known to those skilled in the art. The following definitions are provided to clarify their specific use in the context of this description.

A “device” is a combination of components operably connected to produce one or more desired functions.

A “component” is used broadly to refer to an individual part of a device.

The terms “direct and indirect” describe the actions or physical positions of one component relative to another component. For example, a component that “directly” acts upon or touches another component does so without intervention from an intermediary. Contrarily, a component that “indirectly” acts upon or touches another component does so through an intermediary (e.g., a third component).

“Proximal” and “distal” refer to the relative positions of two or more objects, planes or surfaces. For example, an object that is close in space to a reference point relative to the position of another object is considered proximal to the reference point, whereas an object that is further away in space from a reference point relative to the position of another object is considered distal to the reference point.

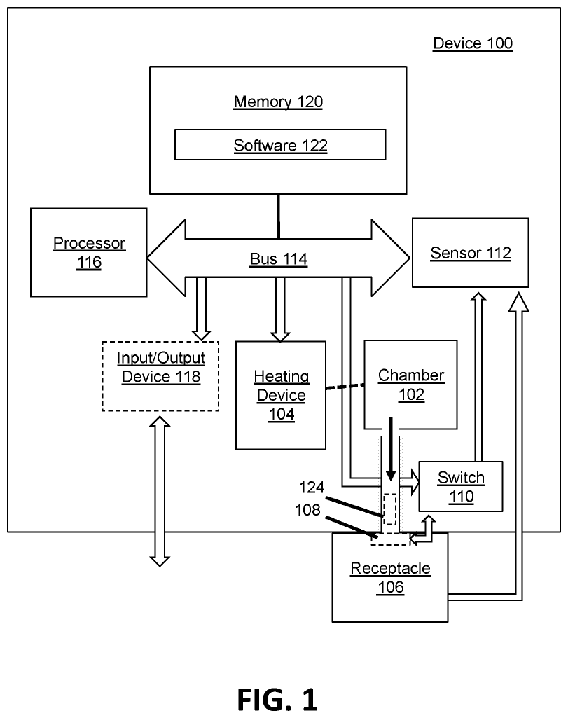

FIG. 1 shows a block diagram of an exemplary vapor dispensing device 100, according to an embodiment. Device 100 comprises a chamber 102 in thermal communication (illustrated as a dashed line) with a heating device 104 such that a solid or a liquid within chamber 102 is heated and converted into a vapor (illustrated as an arrow exiting chamber 102). A receptacle 106, in fluid communication with an outlet of the chamber, receives the vapor through an opening in a bottom of receptacle 106. An optional seal 108 may be disposed between receptacle 106 and chamber 102. As shown, seal 108 is disposed within receptacle 106, but the seal may additionally or alternatively be disposed within device 100 (e.g., at the outlet of chamber 102). Seal 108, when present, is operated by a switch 110, which is in communication with a sensor 112 that detects the presence or absence of receptacle 106 over the outlet of chamber 102. Data from sensor 112 are sent to bus 114, and then to storage (not shown), or to a processor 116. Processor 116, executing software 122, instructs switch 110 to open seal 108 when receptacle 106 is present and to close seal 108 when receptacle 106 is absent. In addition to or as an alternative to the opening and closing of seal 108, when sensor 112 detects the presence or absence of receptacle 106 over the outlet of chamber 102, data from sensor 112 are sent to bus 114, and then to storage (not shown), or to processor 116, which executes software 122 to instruct heating device 104 to turn on when receptacle 106 is present and to turn off when receptacle 106 is absent.

In an embodiment, information, such as temperature, estimated heating time, seal status (open or closed) and the like, may be reported on an output device 118, such as a digital screen. In an embodiment, device 100 may include a filling device 124 configured to fill receptacle 106 with a vapor.

In an embodiment, vapor may be transferred to receptacle 106 mechanically, without processor 116 providing instructions to any moveable components. For example, in an embodiment, the weight of receptacle 106 on a sensor 112, which may be configured as a lever, causes a mechanical switch 110 to physically open seal 108.

Although FIG. 1 illustrates one device 100, structures and functionality presented as a single component may be implemented as separate components. For example, processor 116, memory 120 and software 122 may reside within an external computer that communicates with device 100 through an input/output device 118. Further, a single component, such as device 100, may include multiple structures represented by a single block, e.g., multiple processors 116, chambers 102 and/or sensors 112, may be present in device 100. In addition, wireless communication, e.g., via Bluetooth, Wi-Fi, near field communication, infrared communication and the like, may be used between a vapor dispensing device 100 and another device, such as a computer, smartphone or tablet.

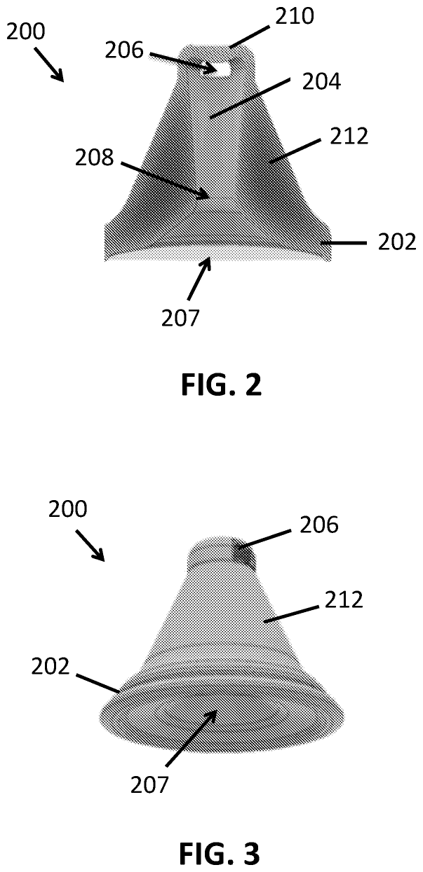

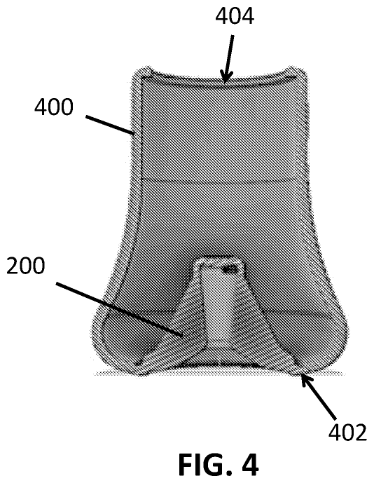

FIG. 2 is a cross sectional illustration of an exemplary diffuser 200 and FIG. 3 is a perspective view of the same. Diffuser 200 includes a gasket 202 for substantially sealing an opening of a receptacle (as shown in FIG. 4), a fluid conduit 204, and an outlet 206. As shown, fluid conduit 204 comprises a wide inlet 207, a waist 208, and a seal 210 at an end distal to gasket 202, which releasably joins with the opening at the bottom of a receptacle. Thus, vapor is forced to focus at waist 208 and exit fluid conduit 204 through one or more outlets 206 that direct vapor substantially laterally relative to the main axis of the fluid conduit. Further, diffuser 200 optionally includes a solid body 212, structural ribs, or other reinforcing features.

FIG. 4 is a cross sectional illustration showing diffuser 200 within a receptacle 400 that comprises an opening 402 at a bottom and an outlet or mouth 404 at a top.

### Statements Regarding Incorporation by Reference and Variations

All references cited throughout this application, for example patent documents including issued or granted patents or equivalents; patent application publications; and non-patent literature documents or other source material; are hereby incorporated by reference herein in their entireties, as though individually incorporated by reference.

The following references relate to containers and devices for bottom-up filling: International Publication No. WO 2007/102139, U.S. Patent Publication No. US 2008/0223478, and U.S. Pat. Nos. 8,777,182 and 8,763,655, each of which is incorporated by reference in its entirety into this application.

The terms and expressions which have been employed herein are used as terms of description and not of limitation, and there is no intention in the use of such terms and expressions of excluding any equivalents of the features shown and described or portions thereof, but it is recognized that various modifications are possible within the scope of the invention claimed. Thus, it should be understood that although the invention has been specifically disclosed by preferred embodiments, exemplary embodiments and optional features, modification and variation of the concepts herein disclosed can be resorted to by those skilled in the art, and that such modifications and variations are considered to be within the scope of this invention as defined by the appended claims. The specific embodiments provided herein are examples of useful embodiments of the invention and it will be apparent to one skilled in the art that the invention can be carried out using a large number of variations of the devices, device components, and method steps set forth in the present description. As will be apparent to one of skill in the art, methods and devices useful for the present methods and devices can include a large number of optional composition and processing elements and steps.

When a group of substituents is disclosed herein, it is understood that all individual members of that group and all subgroups are disclosed separately. When a Markush group or other grouping is used herein, all individual members of the group and all combinations and subcombinations possible of the group are intended to be individually included in the disclosure.

It must be noted that as used herein and in the appended claims, the singular forms “a”, “an”, and “the” include plural reference unless the context clearly dictates otherwise. Thus, for example, reference to “a cartridge” includes a plurality of such cartridges and equivalents thereof known to those skilled in the art, and so forth. As well, the terms “a” (or “an”), “one or more” and “at least one” can be used interchangeably herein. It is also to be noted that the terms “comprising”, “including”, and “having” can be used interchangeably. The expression “of any of claims XX-YY” (wherein XX and YY refer to claim numbers) is intended to provide a multiple dependent claim in the alternative form, and in some embodiments is interchangeable with the expression “as in any one of claims XX-YY.”

Unless defined otherwise, all technical and scientific terms used herein have the same meanings as commonly understood by one of ordinary skill in the art to which this invention belongs. Although any methods and materials similar or equivalent to those described herein can be used in the practice or testing of the present invention, the preferred methods and materials are described. Nothing herein is to be construed as an admission that the invention is not entitled to antedate such disclosure by virtue of prior invention.

Whenever a range is given in the specification, for example, a range of integers, a temperature range, a time range, a composition range, or concentration range, all intermediate ranges and subranges, as well as all individual values included in the ranges given are intended to be included in the disclosure. As used herein, ranges specifically include the values provided as endpoint values of the range. As used herein, ranges specifically include all the integer values of the range. For example, a range of 1 to 100 specifically includes the end point values of 1 and 100. It will be understood that any subranges or individual values in a range or subrange that are included in the description herein can be excluded from the claims herein.

As used herein, “comprising” is synonymous and can be used interchangeably with “including,” “containing,” or “characterized by,” and is inclusive or open-ended and does not exclude additional, unrecited elements or method steps. As used herein, “consisting of” excludes any element, step, or ingredient not specified in the claim element. As used herein, “consisting essentially of” does not exclude materials or steps that do not materially affect the basic and novel characteristics of the claim. In each instance herein any of the terms “comprising”, “consisting essentially of” and “consisting of” can be replaced with either of the other two terms. The invention illustratively described herein suitably can be practiced in the absence of any element or elements or limitation or limitations which is/are not specifically disclosed herein.

All art-known functional equivalents of materials and methods are intended to be included in this disclosure. The terms and expressions which have been employed are used as terms of description and not of limitation, and there is no intention in the use of such terms and expressions of excluding any equivalents of the features shown and described or portions thereof, but it is recognized that various modifications are possible within the scope of the invention claimed. Thus, it should be understood that although the invention has been specifically disclosed by preferred embodiments and optional features, modification and variation of the concepts herein disclosed can be resorted to by those skilled in the art, and that such modifications and variations are considered to be within the scope of this invention as defined by the appended claims.

1. A vapor dispensing device comprising:
a chamber in thermal communication with a heating device such that a solid or a liquid within the chamber is heated and converted into a vapor;
a seal at an outlet of the chamber, the seal comprising a valve biasing the seal in a closed fluid-tight position;
a switch for transitioning the seal from the closed fluid-tight position to an open position when a receptacle is detected in fluid communication with the outlet of the chamber and to close the seal when the receptacle is not in fluid communication with the outlet of the chamber, the receptacle receiving the vapor from the chamber at an opening in a bottom of the receptacle when the seal is in the open position; and
a fan that facilitates movement of the vapor from the chamber to the receptacle.

2. The vapor dispensing device of claim 1, wherein the receptacle comprises a diffuser disposed within the opening in the bottom of the receptacle.

3. The vapor dispensing device of claim 2, wherein the diffuser comprises a gasket and a fluid conduit.

4. The vapor dispensing device of claim 3, wherein the fluid conduit comprises one or more outlets for directing vapor in a substantially lateral direction relative to a main axis of the fluid conduit.

5. The vapor dispensing device of claim 1, wherein the receptacle further comprises one or more outlets.

6. The vapor dispensing device of claim 1, wherein the fan is selected from the group consisting of an electric fan, an electric pump, a piezoelectric fan, a piezoelectric pump, a manual fan, a manual pump, a pneumatic fan and a pneumatic pump.

7. The vapor dispensing device of claim 1, wherein the presence or absence of the receptacle is detected by a sensor that provides detection data to a processor that instructs the heating device to turn on or ramp up when the receptacle is present and to turn off or ramp down when the receptacle is absent.

8. The vapor dispensing device of claim 7, wherein the heating device operates in low mode in the absence of the receptacle.

9. The vapor dispensing device of claim 1, wherein the presence or absence of the receptacle is detected by a sensor that provides detection data to a processor that instructs the fan to turn on or speed up when the receptacle is present and to turn off or slow down when the receptacle is absent.

10. The vapor dispensing device of claim 1 further comprising a non-transitory computer-readable medium having a plurality of non-transitory instructions executable by a processor for cleaning the device, the plurality of non-transitory instructions being executable for:
activating the heating device to raise a temperature of the chamber to at least 200 degrees Fahrenheit; and/or
activating the fan to provide a pressure of at least 10 psi.

11. The vapor dispensing device of claim 1, wherein the heating device is a convective heating device, a conductive heating device, or a combination thereof.

12. The vapor dispensing device of claim 1, wherein the heating device is selected from the group consisting of a resistive element, a heating bath, a flame and combinations thereof.

13. The vapor dispensing device of claim 1, wherein the chamber is configured to receive a cartridge comprising the solid or the liquid.

14. The vapor dispensing device of claim 1, wherein the seal is magnetic, electromagnetic, mechanical or electromechanical.

15. The vapor dispensing device of claim 1, wherein the switch is magnetic, electromagnetic, mechanical, electromechanical and/or digital.

16. The vapor dispensing device of claim 15, wherein the switch is a solenoid, a mechanical switch, an electronic switch or a transistor.

17. A method of dispensing a vapor from a device comprising:
providing the vapor dispensing device of claim 1;
detecting with a sensor the presence or absence of a receptacle over an outlet of the chamber; and
causing:
(i) the heating device to increase or decrease a temperature of the chamber based on whether the sensor detects the presence or absence of the receptacle, respectively;
(ii) the switch to open or close the seal at the outlet of the chamber based on whether the sensor detects the presence or absence of the receptacle, respectively; and/or
(iii) the fan to increase or decrease its speed based on whether the sensor detects the presence or absence of the receptacle, respectively.

18. A method of dispensing vapor comprising:
providing the vapor dispensing device of claim 1;
placing a solid or liquid within the chamber of the vapor dispensing device;
delivering power to the device to heat the chamber and convert the solid or liquid into vapor; and
placing the receptacle comprising the opening in the bottom of the receptacle over the outlet of the chamber, thereby causing the switch to transition the seal at the outlet of the chamber to the open position and the vapor to be dispensed into the receptacle.

19. The method of claim 18 further comprising inserting a diffuser in the opening in the bottom of the receptacle before placing the receptacle over the outlet of the chamber.

20. The method of claim 18, wherein the solid or the liquid is disposed within a cartridge.
